(19) United States
(12) Patent Application Publication
(10) Pub. No.: US 2024/0330428 A1
(43) Pub. Date: Oct. 3, 2024

(54) QUORUM BASED TRANSFER OF COMPUTER-IMPLEMENTED RESOURCES

(71) Applicant: Amazon Technologies, Inc., Seattle, WA (US)

(72) Inventors: Ivan Velickovic, Vancouver (CA); Steve Robert DeVos, Mercer Island, WA (US); James Michael Rolette, Round Rock, TX (US); Aram Golbaghikoukia, Coquitlam (CA); Thiago Macedo De Sousa, Langley (CA); Vivek Mishra, Bothell, WA (US); Soumyajit Das, Everett, WA (US); Shubham Anand, Seattle, WA (US); Boo Boon Khoo, Bellevue, WA (US)

(21) Appl. No.: 18/129,739

(22) Filed: Mar. 31, 2023

(51) Int. Cl. G06F 21/40; G06F 21/55

(52) U.S. Cl. CPC G06F 21/40; G06F 21/554; G06F 2221/2141

(57) ABSTRACT

Described techniques and systems can identify a request to transfer one or more computer-implemented resources associated with a first computer-implemented account to a second computer-implemented account, the one or more computer-implemented resources at least in part managed through a service accessible by at least one entity selected to consider the request, the service implemented separately from another service to manage access to the one or more computer-implemented resources. Also, the techniques and systems can confirm the at least one entity approved the request to transfer the one or more computer-implemented resources associated with the first computer-implemented account, and transfer the one or more computer-implemented resources to the second computer-implemented account.

### BACKGROUND

Online service providers can provide customers various services for utilization. Some services can be provided for a fee and other services can be provided on a no fee basis. Generally, a customer establishes an account with a provider to gain access to the services provided by the provider. For example, the customer can setup an account with the provider and subsequently gain access to one or more services provided by the provider. The services offered by the provider may include associated computer-implemented resources that store data based on a customer's use of the services. These computer-implemented resources can be unavailable if the customer's account is rendered unusable, such as if the customer's account is compromised by a malicious entity.

### BRIEF DESCRIPTION OF THE DRAWINGS

Various techniques will be described with reference to the drawings, in which:

FIG. 1 illustrates an example system environment in which one or more computer-implemented resources can be transferred from a first account to a second account, according to at least one embodiment;

FIG. 2 illustrates an example registration process for creating a quorum group and optionally creating a computer-implemented resource for association with the quorum group, according to at least one embodiment;

FIG. 3 illustrates an example transfer process for transferring a computer-implemented resource from a first account to a second account, according to at least one embodiment;

FIG. 4 illustrates an example update quorum group process for adding or removing an entity to a quorum group, according to at least one embodiment;

FIG. 5 illustrates an example flow diagram that may be associated with one or more of the described system environments to process transferring a computer-implemented resource from a first account to a second account, according to at least one embodiment;

FIG. 6 illustrates an example flow diagram that may be associated with one or more of the described system environments to process transferring a computer-implemented resource from a first account to a second account, according to at least one embodiment;

FIG. 7 illustrates an example flow diagram that may be associated with one or more of the described system environments to process transferring a computer-implemented resource from a first account to a second account, according to at least one embodiment; and

FIG. 8 illustrates a system in which various embodiments can be implemented.

### DETAILED DESCRIPTION

Techniques and systems to facilitate transfer of a computer-implemented resource to an account are disclosed. The computer-implemented resource can be transferred to the account via a quorum service. The quorum service can be implemented separately of an identity and access management (IAM) service linked to the account, where the IAM service is implemented to securely control access to the computer-implemented resource. Separating the quorum service from the IAM service alleviates having to consider the integrity of the IAM service before the computer-implemented resource is considered for transfer to the account.

The described quorum service can be provided to facilitate transferring a computer-implemented resource of a first account to a second account. The computer-implemented resource can be transferred to the second account based on a variety of reasons. For example, the first account might be placed in quarantine or indicated for closure due to a malicious act. The malicious act can be perpetrated by an insider, such as a disgruntled individual, associated with the account. Alternatively, the malicious act can be perpetrated by an outsider, such as a hacker attempting to misappropriate data associated with the account. In another example, the computer-implemented resource of the first account might be identified for transfer to the second account for administrative purposes, such as when data of the computer-implemented resource is to be transferred to owners of the second account.

The described quorum service can have two interfaces. A first of the two interfaces can be used by an administrator to configure the quorum service. For example, the administrator can access the first interface to instantiate a quorum group, modify a quorum group, and initiate revocation of a quorum group. A second of the two interfaces can be used by members of the quorum group. For example, each member of the quorum group can access the quorum service to respond to requests to transfer computer-implemented resources.

The quorum group can include a minimum of three entities. In at least one embodiment, the minimum is less than three or more than three. For example, the minimum can be one or more entities. The entities can be individuals, intelligent machine entities, and/or a combination of individuals and intelligent machine entities. In addition, the quorum group can be instantiated to be linked to a computer-implemented resource. An identifier of the computer-implemented resource can be used to link the quorum group to the computer-implement resource.

As alluded to, the quorum service can be used to transfer a computer-implemented resource from a customer's compromised account to a new account. Once the quorum group is active, the process of transferring the computer-implemented resource to the new account is straightforward. Moreover, the risk of a bad actor, such as an individual or entity involved in compromising the account, being involved in the transfer of the computer-implemented resource is substantially eliminated because the quorum service is functionally separate from the IAM service of the compromised account. Moreover, in at least one embodiment, the computer-implemented resource is maintained in the system infrastructure outside of the control of the compromised account. In at least one embodiment, the computer-implemented resource is implemented in system infrastructure of an online service provider and one or more keys belonging to the online service provider are used to encrypt/decrypt data hosted by the computer-implement a resource.

An administrator of the compromised account can initiate transfer of the computer-implemented resource of the compromised account via one or more services of the new account. In an example, the computer-implemented resource for transfer is a computer-implemented storage with backup data from the compromised account. For example, the computer-implemented storage can be a backup vault, such as a logically air-gapped vault that includes backup data. In at least one embodiment, the computer-implemented storage is implemented in system infrastructure outside of the system infrastructure associated with the compromised account. Such a vault can store immutable backup copies in a set of one or more service-owned accounts separate from a customer's account infrastructure from where the data of the backup copies is used, originated, and/or stored. Backups stored in the vault can be encrypted/decrypted with one or more keys that are also outside of the customer's account infrastructure, such as keys that are maintained and controlled by an online service provider. In this example, the administrator of the compromised account connects to a backup service that can be used to administrator the computer-implemented storage with the backup data from the compromised account.

The administrator of the computer-implemented storage initiates the transfer through the backup service by identifying or selecting the computer-implemented storage using a unique identifier assigned to the computer-implemented storage. In an example, the administrator of the computer-implemented storage, through the backup service, can connect to the quorum service through a first programmatic interface that accepts the unique identifier assigned to the computer-implemented storage. The quorum service can respond by acknowledging the request to transfer the computer-implemented storage and generating a communication that is sent to each entity in the quorum group linked to the computer-implemented storage. The communication can be sent to the entities of the quorum group via email. The communication can identify the computer-implemented storage for transfer and include a request to approve the transfer of the computer-implemented storage.

Each entity in the quorum group can respond to the communication by connecting to the quorum service. In an example, the quorum service offers a second interface, such as a programmatic interface or a uniform resource locator (URL) interface. Each entity in the quorum group can respond to the communication through the second interface. Specifically, an entity in the quorum group can approve the request to transfer the computer-implemented storage by connecting to the quorum service through the second interface to submit their approval. Once a majority of the quorum group responds with an approval to transfer the computer-implemented storage, the quorum service can send an approval notification to the backup service. The approval notification can trigger the backup service to transfer the computer-implemented storage to the new account.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure, certain embodiments may be capable of achieving certain advantages, including some or all of the following: (1) using a quorum service that is isolated from the IAM service advantageously reduces the use of computer resources to initiate and execute computer-implemented resources from a first account to a second account; (2) when an account is compromised by a malicious entity, all computer-implemented resources of the account may be compromised and unrecoverable due to the possible compromised state of the computer-implemented resources; the described implementations facilitate transfer of computer-implemented resources through the isolation of the service that facilitates the transfer, thereby resulting in improved system and resource use to facilitate the transfer; (3) use of the quorum service to facilitate computer-implemented resource transfer can improve efficiencies of an online service provider's computer-implemented systems by reducing an amount of time required to execute the transfer, resulting in improved efficiencies related to the use of computer-implemented systems of the online service provider.

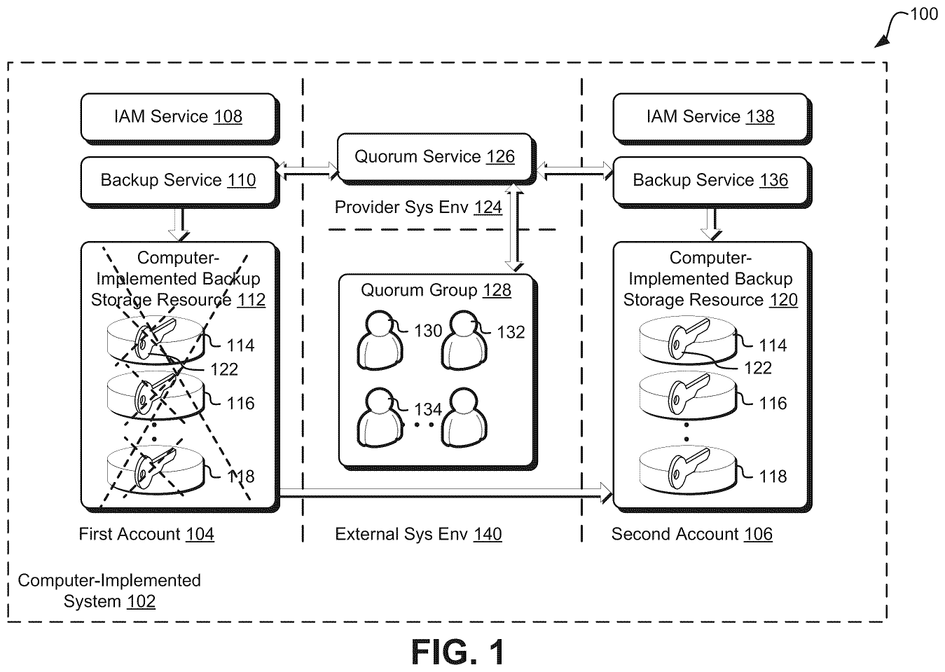

FIG. 1 illustrates an example system environment 100 in which one or more computer-implemented resources can transferred from a first account 104 to a second account 106, according to at least one embodiment. The example system environment 100 can include a computer-implemented system 102. The computer-implemented system 102 can comprise various computational resources, including virtual computer instances, applications, services, processes, web servers, computer storage, database instances, networking components, and so on. In some embodiments, the computer-implemented system 102 can be hosted in the cloud by an online service provider.

The first account 104 can include an IAM service 108, a backup service 110, and a computer-implemented backup storage resource 112. The backup service 110 may be a collection of computing resources, including physical resources, virtual resources, or combinations thereof, and can include computer-executable instructions usable to allow the backup service 110 to perform various tasks and actions. The backup service 110 can host a backup schedule for the retention of a customer's data. As an example, consider a customer with a set of data that needs to be backed up on a regular basis. The set of data may include purchase records, or inventory data, or source code, or some other data. The customer might specify that a full backup of all of the data should be made every three months and that full backup should be retained indefinitely (e.g., for as long as the customer maintains an account in good standing). The customer might also specify weekly backups that are retained for a month (e.g., for four weeks), and daily backups that are retained for a week (i.e., for seven days). Thus, at any time, the customer can restore data from any quarterly backup, from any week for the last four weeks, or from any day for the last week. In this example, the quarterly backup can be efficiently stored in long-term storage as a full backup, but the weekly and daily backups require processing in order to be stored efficiently. An administrator of the customer can use the backup service 110 to configure the retention of data associated with the first account 104.

The IAM service 108 may be a collection of computing resources, including physical resources, virtual resources, or combinations thereof, configured to control access to resources provided by the computer-implemented system 102 and/or the provider of the system 102. In some embodiments, the IAM service 108 stores credentials and its access policies or granted privileges. In at least one embodiment, the credential and its policies control access to computing resources. In some embodiments, a credential may include an access key ID, which may be a unique identifier for the credential, and a key, which may be used to perform cryptographic operations such as signing the messages or requests, encrypting data, and the like. In some embodiments, the key may be a symmetric key so that a single key is used to sign and verify a message. In some embodiments, the key may include a pair of asymmetric keys so that the signing key (e.g., a private key) is different from the verification key (e.g., a public key).

The computer-implemented backup storage resource 112 can store data for a customer. One or more servers, systems or devices, can be configured to implement the computer-implemented backup storage resource 112. Computer-implemented resources, for which data may be stored in the computer-implemented backup storage resource 112, may be any type of application, device, or system that may be configured to communicate with or access data stored in the computer-implemented backup storage resource 112. In at least one embodiment, the computer-implemented backup storage resource 112 is identified by a unique identifier, such as an identifier that can be used to locate the computer-implemented backup storage resource 112 unambiguously across all services and systems of the computer-implemented system 102, such as in IAM policies, and programmatic interface calls, such as application programming interface (API) calls, communications of the backup service 110, and other systems and services implemented by the computer-implemented system 102. In at least one embodiment, the computer-implemented backup storage resource 112 is a data vault. In at least one embodiment, the computer having implemented backup storage resource 112 is a logically air-gapped vault that includes backup data. In at least one embodiment, a logically air-gapped vault is one or more computer-implemented storages. For example, a logically air-gapped vault can be one or more computer-implemented storages that include data. This data can be backup or redundantly stored data of a customer of an online service provider that provides the system environment 100. In at least one embodiment, the logically air-gapped vault is managed by the online service provider on behalf of a customer whose data is stored in the logically air-gapped vault. For example, the logically air-gapped vault can be implemented external of the customer's computer-implemented system environment and/or account environment. In at least one embodiment, data stored in the logically air-gapped vault is encrypted with one or more keys managed by the online service provider. In at least one embodiment, the one or more keys are not directly useable and/or can not be accessed by the customer of the online service provider. In at least one embodiment, data for storage in the logically air-gapped vault is communicated from the customer's account environment (e.g., computer-implemented environment) to the online service provider's system environment (e.g., external environment). The data is encrypted by one or more keys owned or held by computer-implemented systems of the online service provider and stored in the logically air-gapped vault.

In at least one embodiment, the computer-implemented backup storage resource 112 can comprise one or more datasets 114-118. Any number of datasets can be hosted by the computer-implemented backup storage resource 112. Each one of the datasets 114-118 can be mapped to a recovery point. Specifically, in at least one embodiment, a data backup operation may involve some kind of access to the computer-implemented backup storage resource 112 and may, in various embodiments, involve one or more writes to the computer-implemented backup storage resource 112. For example, as part of a recovery operation, different metadata or other information about the backup data of the computer-implemented backup storage resource 112 may be written to different storage nodes in a distributed data store maintaining the backup data. Recovery of backup data may involve determining a recovery point in the log data assigned to the datasets 114-118. Each dataset 114-118 can have an associated recovery point to facilitate identifying data for recovery and/or transfer of the dataset. In at least one embodiment, the recovery point for a given dataset is assigned either exclusively or for other purposes to facilitate transfer of the datasets 114-118 to a new computer-implemented backup storage resource, such as computer-implemented backup storage resource 120.

Data of the computer-implemented backup storage resource 112 can be encrypted.

Specifically, one or more encryption keys 122 can be used to encrypt the data of the datasets 114-118. Unlike conventional techniques that encrypt customer data using one or more keys managed by a customer's account, the one or more encryption keys 122 are not associated with policies of the IAM service 108 belonging to the first account 104. Rather, the one or more encryption keys 122 or provider-provided encryption keys are associated with the provider of the computer-implemented system 102 and are controlled by the provider of the computer-implemented system 102. In at least one embodiment, the one or more encryption keys 122 are generated, controlled, and/or administered by one or more services of a provider system environment 124. The provider system environment 124 can be administered by the provider of the computer-implemented system 102. In at least one embodiment, the computer-implemented backup storage resource 112 is a computer-implemented resource of the provider system environment 124 that is managed and/or administered solely by the provider of the computer-implemented system 102. In at least one embodiment, the computer-implemented backup storage resource 112 is implemented external of the system environment of the first account 104, such as in the provider system environment 124 or some other system environment that is external to the system environment of the first account 104.

The computer-implemented system 102 can implement a quorum service 126. In at least one embodiment, the quorum service 126 is part of the provider system environment 124. The quorum service 126 may be a collection of computing resources, including physical resources, virtual resources, or combinations thereof, and can include computer-executable instructions usable to allow the quorum service 126 to perform various tasks and actions. In at least one embodiment, the quorum service 126 is tasked and configured to coordinate transferring data from the computer-implemented backup storage resource 112 to the computer-implemented backup storage resource 120 of the second account 106. In at least one embodiment, the quorum service 126 is tasked and configured to coordinate transferring the computer-implemented backup storage resource 112 to the second account 106, such as removing the computer-implemented backup storage resource 112 from the first account 104 and associating the resource 112 with the second account 106 as computer-implemented backup storage resource 120.

The backup service 110 can interface with the quorum service 126. In at least one embodiment, an administrator associated with the backup service 110 can interface with the quorum service 126 to create a quorum group 128. In at least one embodiment, the quorum group 128 is to include at least three entities 130-134. In at least one embodiment, the quorum group can include any number of entities specified by the administrator. The administrator can specify the minimum number of entities that are to be in the quorum group. In at least one embodiment, the minimum number of entities in the quorum group is one or more entities. In at least one embodiment, the entities 130-134 can be human individuals. In at least one embodiment, the entities 130-134 can be machine-based artificial intelligence entities. In at least one embodiment, the entities 130-134 can be a mix of human individuals and machine-based artificial intelligence entities.

To initiate creating and linking the quorum group 128 to approve transfer of backup data and/or the computer-implemented backup storage resource 112, the administrator of the backup service 110 can provide one or more unique identifiers to the quorum service 126. These unique identifiers can be used to locate one or more of the datasets 114-118 and/or the computer-implemented backup storage resource 112. In addition, in at least one embodiment, the administrator of the backup service 110 can supply contact information for each of the three entities 130-134. For example, the contact information can comprise an email address or other such contact information for each of the three entities 130-134. Furthermore, in at least one embodiment, the administrator of the backup service 110 can specify a quorum member threshold to identify a minimum number of entities required to participate in the quorum group 128. The threshold can be at least one or greater. Additionally, in at least one embodiment, the administrator of the backup service 110 can specify a quorum threshold to indicate a minimum number of approving entities before a transfer request is determined to be approved by the quorum service 126.

The quorum service 126 can contact the three entities 130-134. In at least one embodiment, the quorum service 126 can use the provided contact information to contact the three entities 130-134. In at least one embodiment, contacting the at least three entities 130-134 includes sending an email or other message to the three entities 130-134. Some or all of the three entities 130-134 may be associated with an external system environment 140. In at least one embodiment, some or part of the external system environment 140 can be associated with the Internet. In at least one embodiment, some or all of the three entities 130-134 can be associated with the computer-implemented system 102.

The email or other message to each of the three entities 130-134 can identify the name associated with a quorum group that is to include each of the three entities 130-134, a unique identifier for the quorum group, a short description of the quorum group's purpose, and a description as to how the recipient of the email or other message can respond to accept the invitation to participate in the quorum group. The description can be a simple URL link usable by the recipient to interface with the quorum service 126. Alternatively, the description can indicate that the recipient can respond via email. In at least one embodiment, a URL associated with the URL link is temporary and can expire after a predetermined time period.

Via return email or URL access, the quorum service 126 can receive one or more acknowledgments or acceptances from the one or more three entities 130-134 to participate in the quorum group. The quorum service 132 can determine if the received one or more acknowledgments or acceptances equal or exceed the quorum member threshold. In at least one embodiment, as described, the quorum member threshold indicates a minimum number of entities required to participate in the quorum group 128. In at least one embodiment, based on the received one or more acknowledgments or acceptances from the one or more three entities 130-134, the quorum service 126 creates the quorum group 128.

The second account can include a backup service 136 and an IAM service 138. The backup service 136 may be a collection of computing resources, including physical resources, virtual resources, or combinations thereof, and can include computer-executable instructions usable to allow the backup service 136 to perform various tasks and actions. The backup service 136 can host a backup schedule for the retention of a customer's data. As an example, consider a customer with a set of data that needs to be backed up on a regular basis. The set of data may include purchase records, or inventory data, or source code, or some other data. The customer might specify that a full backup of all of the data should be made every three months and that full backup should be retained indefinitely (e.g., for as long as the customer maintains an account in good standing). The customer might also specify weekly backups that are retained for a month (e.g., for four weeks), and daily backups that are retained for a week (i.e., for seven days). Thus, at any time, the customer can restore data from any quarterly backup, from any week for the last four weeks, or from any day for the last week. In this example, the quarterly backup can be efficiently stored in long-term storage as a full backup, but the weekly and daily backups require processing in order to be stored efficiently. An administrator of the customer can use the backup service 136 to configure the retention of data associated with the second account 106.

The IAM service 138 may be a collection of computing resources, including physical resources, virtual resources, or combinations thereof, configured to control access to resources provided by the computer-implemented system 102 and/or the provider of the system 102. In some embodiments, the IAM service 138 stores credentials and its access policies or granted privileges. In at least one embodiment, the credential and its policies control access to computing resources. In some embodiments, a credential may include an access key ID, which may be a unique identifier for the credential, and a key, which may be used to perform cryptographic operations such as signing the messages or requests, encrypting data, and the like. In some embodiments, the key may be a symmetric key so that a single key is used to sign and verify a message. In some embodiments, the key may include a pair of asymmetric keys so that the signing key (e.g., a private key) is different from the verification key (e.g., a public key).

In at least one embodiment, transfer of one or more computer-implemented resources associated with the first account 104 can be desired or even necessary. For example, the first account 104 can be placed in quarantine or deemed unsatisfactory for further use. This can occur when a malicious entity, such as one or more hackers or insiders, compromises systems and/or services of the first account 104. In another example, transfer of one or more computer-implemented resources associated with the first account 104 can be required when there is an ownership shift or administrative need to move resources from the first account 104 to another account, such as the second account 106.

In at least one embodiment, transfer of one or more computer-implemented resources associated with the first account 104 can be initiated from one or more services of the second account 106. For example, using the backup service 136, an administrator can interface with the quorum service 126 to request transfer of the computer-implemented backup storage resource 112 to the second account 106. In at least one embodiment, using the backup service 136, an administrator can interface with the quorum service 126 to request transfer of one or more of the datasets 114-118 to the second account 106.

To initiate the transfer, the administrator of the backup service 136 generates a transfer request that includes one or more identifiers of the computer-implemented resources for transfer from the first account 104 to the second account 106. The transfer request can be initiated through a programmatic interface of the quorum service 126. In at least one embodiment, the transfer request is an API call to the quorum service 126 that includes at least the one or more unique identifiers associated with the computer-implemented resources to be transferred from the first account 104 to the second account 106. In at least one embodiment, the one or more unique identifiers are associated with the computer-implemented backup storage resource 112 and/or the datasets 114-118. In addition, the transfer request can include a short description or message indicating the purpose or reason for the transfer request. In at least one embodiment, the programmatic interface of the quorum service 126 can process the short description or message indicating the purpose or reason for the transfer request. In at least one embodiment, the programmatic interface of the quorum service 126 can comprise one or more APIs, web pages, custom graphical user interfaces, command-line tools, or the like.

The quorum service 126 can generate a transfer approval request communication in response to receiving the transfer request from the backup service 136. The transfer approval request communication can be an email or other message for delivery to each entity of the quorum group 128. The transfer approval request communication can comprise a URL link associated with a URL or other interface of the quorum service 126. Availability to access the URL or other interface of the quorum service 126 can be limited to a particular time period and/or can be set to terminate based on a predetermined timeframe set by an administrator of the quorum service 126.

In at least one embodiment, the URL link can allow entities of the quorum group 128 to interface with the quorum service 126 to approve transfer of the one or more computer-implemented resources 112/114-118 from the first account 104 to the second account 106. In at least one embodiment, accessing the quorum service 126 via the provided URL can cause the display of a web page that details the transfer request and can include specifics (e.g., unique identifiers, data type, storage type, resource names, resource types, dataset name, dataset size, etc.) of the one or more computer-implemented resources for transfer from the first account 104 to the second account 106. In addition, in at least one embodiment, the web page can offer a mechanism that allows the at least three entities 130-134 to approve or reject the transfer request.

The quorum service 126 monitors approvals to the transfer request received from one or more of the at least three entities 130-134. In at least one embodiment, the quorum service 126 can determine when the number of approvals from the at least three entities 130-134 equals or exceeds the quorum threshold. In at least one embodiment, once the number of approvals from the at least three entities 130-134 equals or exceeds the quorum threshold, the quorum service 126 executes transfer of the computer-implemented resources associated with the transfer request from the backup service 136. In at least one embodiment, execution of the transfer of the computer-implemented resources associated with the transfer request can include mapping one or more unique identifiers of the computer-implemented resources from the first account 104 to the second account 106. In at least one embodiment, mapping the one or more unique identifiers of the computer-implemented resources to the second account 106 can include linking an account identifier of the second account 106 to the metadata of the computer-implemented resources transferred to the second account 106.

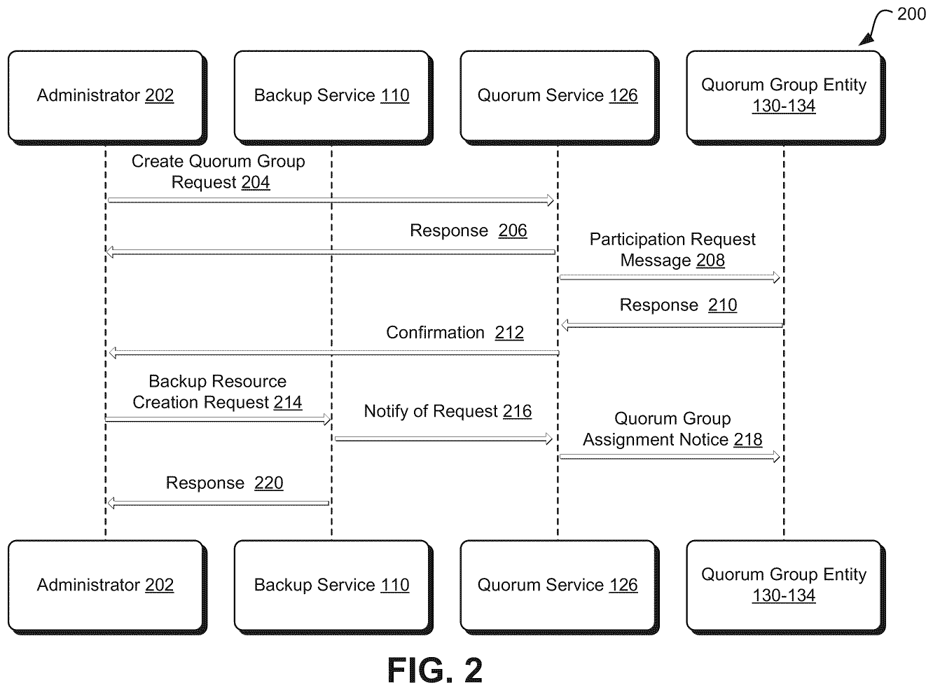

FIG. 2 illustrates an example registration process 200 for creating a quorum group and optionally creating a computer-implemented resource for association with the quorum group, according to at least one embodiment. In at least one embodiment, the computer-implemented resource can be a computer-implemented resource comprising one or more datasets, such as one or more backup datasets. In at least one embodiment, the computer-implemented resource can be a computer-implemented storage. In at least one embodiment, the computer-implemented resource can be a computer-implemented virtual machine. In at least one embodiment, the computer-implemented resource can be a collection of computer-implemented storages and/or virtual machines. In at least one embodiment, the computer-implemented resource is a customer account. In at least one embodiment, the computer-implemented resource is a data structure, such as a database.

In at least one embodiment, an administrator 202, such as an administrator of the computer-implemented system 102, an administrator of the first account 104, an administrator of the backup service 110, or the like, generates a create quorum group request 204. In at least one embodiment, the request 204 can be generated through the backup service 110 or another service of the computer-implemented system 102. The request 204 can be communicated to the quorum service 126. The request 204 can include a unique identifier associated with the computer-implemented resource that a quorum group is to be associated with. Furthermore, the request 204 can include contact information for at least three entities that are to be associated with the quorum group. In at least one embodiment, the request 204 can include a short description identifying the purpose for the quorum group. For example, the short description can identify that the quorum group is to approve transfer requests associated with the identified computer-implemented resource. In addition, the request 204 can include a quorum threshold to indicate a minimum number of approving entities before a transfer request is determined to be approved by the quorum service 126. In at least one embodiment, the request 204 can include a quorum member threshold to identify a minimum number of entities required to participate in the quorum group. The quorum service 126 can provide a response 206 confirming receipt of the request 204.

The quorum service 126 can generate a participation request message 208. In addition, in response to receiving the request 204, the quorum service 126 can save and/or create entity information for each entity identified in the request 204. The participation request message 208 can be sent to each entity identified in the request 204. The contact information included in the request 204 can be used to contact each entity identified in the request 204. The participation request message 208 can identify the name of the quorum group that the entity is to be associated with. Furthermore, the message 208, in at least one embodiment, can include a unique identifier for the quorum group. In at least one embodiment, the message 208 provides a short description identifying one or more purposes for the quorum group. For example, the short description can identify that the quorum group is to approve transfer of one or more computer-implemented resources from account to account. Additionally, the message 208 can describe how the entity can indicate their approval to participate in the quorum group. In at least one embodiment, the message 208 includes a link to the URL. The URL may be associated with the quorum service 126. In at least one embodiment, the URL is a temporary interface arranged by the quorum service 126 to accept entity responses to the message 208.

The quorum service 126 can receive one or more responses 210 from the entities identified in the message 208. In at least one embodiment, the one or more responses 210 are received from the entities 130-134. In at least one embodiment, the one or more responses 210 are received via a dedicated interface of the quorum service 126. In at least one embodiment, the quorum service 126 can require the entities 130-134 to perform a logon or login process in advance of providing their response to the message 208. In at least one embodiment, the quorum service 126 creates the quorum group once approvals from the entities 130-134 to participate in the quorum group are received. In at least one embodiment, the quorum service 126 creates the quorum group once the quorum service 126 determines the received acceptances from the one or more entities 130-134 equal or exceed the quorum member threshold. After the quorum group is created, the quorum service 126 can generate a confirmation 212. In at least one embodiment, the confirmation 212 is communicated to the administrator 202. The confirmation 212 can include the name of the quorum group, list the entities associated with the quorum group, and identify the quorum group by its unique identifier.

In at least one embodiment, the process 200 can also include the creation of a computer-implemented resource and associating the computer-implemented resource with the quorum group.

In at least one embodiment, the computer-implemented resource can be a computer-implemented backup storage resource, such as the resource 112, one or more datasets, such as the datasets 114-118, and so forth. The administrator 202 can generate a resource creation request 214. In at least one embodiment, the request 214 is a request to create a computer-implemented backup storage resource, such as the resource 112. The request 214 can include a name for the computer-implemented resource. Moreover, the request 214, in at least one embodiment, can identify a quorum group to be associated with the computer-implemented resource. For example, the request 214 can include a unique identifier of the quorum group. Alternatively, or in addition, the request 214 can include the name associated with the quorum group. In at least one embodiment, the request 214 is received by one or more services of the computer-implemented system 102. In at least one embodiment, the backup service 110 receives the request 214.

The backup service 110 can send a notification 216 of the request 214 to the quorum service 126. The notification 216 can identify that a previously created quorum group is to be assigned to consider transfer requests for the computer-implemented resource identified in the request 214. In at least one embodiment, the notification 216 can identify the quorum group by quorum group name and/or quorum group unique identifier. The quorum service 126, in at least one embodiment, can send a message or notice 218 to the quorum group including the entities 130-134 to notify each of the entities 130-134 that the quorum group is associated with the computer-implemented resource. The notice 218 can include a short description identifying why the quorum group has been associated with the computer-implemented resource, such as describing that the quorum group is to consider transfer requests for the computer-implemented resource. In at least one embodiment, the backup service 110 can provide a response 220 to the administrator 202. The response 220 can identify/confirm the creation of the computer-implemented resource. The response 220, in at least one embodiment, can include a unique identifier of the computer-implemented resource and/or a name of the computer-implemented resource.

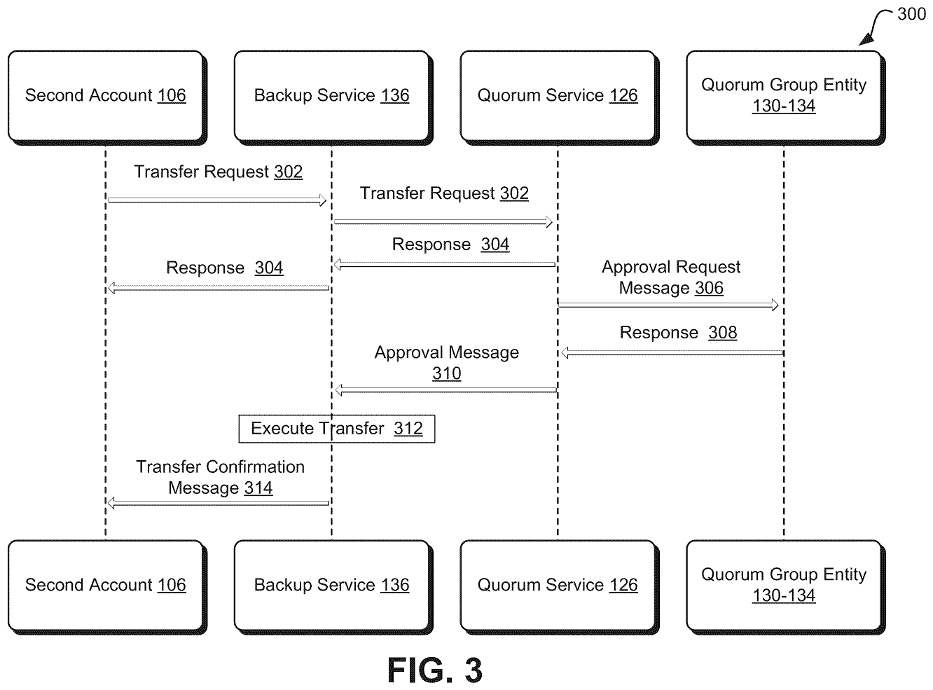

FIG. 3 illustrates an example transfer process 300 for transferring a computer-implemented resource from a first account to a second account, according to at least one embodiment. In at least one embodiment, the transfer process 300 can be used to transfer one or more computer-implemented resources from the first account 104 to the second account 106. In at least one embodiment, the second account 106 is a recovery account established after determining the first account 104 is to be closed or has been placed in quarantine due to the first account 104 being compromised by a one or more malicious actors.

An administrator at the second account 106 can generate a transfer request 302. In at least one embodiment, the transfer request 302 can be generated by one or more services of the second account 106 and/or one or more services of the computer-implemented system 102. In at least one embodiment, the transfer request 302 can be generated via the backup service 136. The transfer request 302 can identify the computer-implemented resource for transfer to the second account 106. In at least one embodiment, the transfer request 302 can include a unique identifier associated with the computer-implemented resource for transfer and/or a name associated with the computer-implemented resource for transfer. In at least one embodiment, the transfer request 302 identifies the computer-implemented backup storage resource 112 and/or one or more datasets 114-118. In addition, in at least one embodiment, the transfer request 302 can include a description identifying one or more reasons for the transfer request 302. In at least one embodiment, the computer-implement resource for transfer is implemented or situated outside of a system environment of the first account but is nonetheless associated with the first account. In at least one embodiment, the computer-implemented resource for transfer is realized or situated in a system environment of a provider of one or more online services. In at least one embodiment, an entity, such as one or more users or a corporation, uses the provider to arrange/setup the system environment for the first account. The computer-implemented resource for transfer can host backup data from computer-implemented resources of the first account. The computer-implemented resource for transfer can be a backup vault, such as an air-gapped vault.

The quorum service 126 can receive the transfer request 302. In response to the transfer request 302, a response 304, such as a confirmation that the transfer request 302 was received, can be generated and delivered to the backup service 136 and/or an administrator of the second account 106. Furthermore, in at least one embodiment and based on the transfer request 302, the quorum service 126 can generate and send a transfer approval request message 306 to each of the entities 130-134 in the quorum group linked to the computer-implemented resource for transfer.

Specifically, as described, the quorum group can have an associated identifier or name that is linked to the computer-implemented resource for transfer based on an identifier or name of the computer-implemented resource for transfer. The quorum service 126 can query the database or other searchable computer-implemented storage to determine which if any quorum group is associated with the computer-implemented resource for transfer.

In at least one embodiment, the transfer approval request message 306 includes a request to approve the transfer of the computer-implemented resource. The message 306 can include a link to a URL, such as a URL of the quorum service 126, that the entities 130-134 can use to interface with the quorum service 126 in order to approve or reject the transfer request identified in the message 306. In at least one embodiment, the interface of the quorum service 126 is a programmatic interface, such as one or more APIs, web pages, custom graphical user interfaces, command-line tools, or the like.

A response 308 can be received by the quorum service 126. The response 308 can indicate an entity's approval of the transfer of the computer-implemented resource from the first account 104 to the second account 106. In at least one embodiment, the response 308 is provided through a temporary or time-limited interface of the quorum service 126. In at least one embodiment, a number of entity approvals received by the quorum service 126 is compared against a quorum threshold indicating a minimum number of approving entities. When the approvals equal or exceed the quorum threshold, an approval message 310 can be sent from the quorum service 126 to the backup service 136 and/or an administrator of the second account 106. The approval message 310 can identify that the computer-implemented resource for transfer is approved for transfer. The message 310 can include the identifier and/or name of the computer-implemented resource for transfer. In at least one embodiment, based on the approval message 310, the backup service 136 can execute the transfer of the computer-implemented resource from the first account 104 to the second account 106. Executing the transfer of the computer-implemented resource can include changing the metadata of the computer-implemented resource to reflect that the computer-implemented resource is associated with the second account 106. For example, the metadata can include a field for identifying the account that the computer-implemented resource is associated with. The field can be updated to remove the identifier of the first account 104 and add the identifier of the second account 106. The backup service 136 can generate a transfer confirmation message 314. The transfer confirmation message 314 can include information confirming the transfer of the computer-implemented resource from the first account 104 to the second account 106. Such confirming information can include identifying information of the computer-implemented resource, identifying information of the first account 104 and/or identifying information of the second account 106.

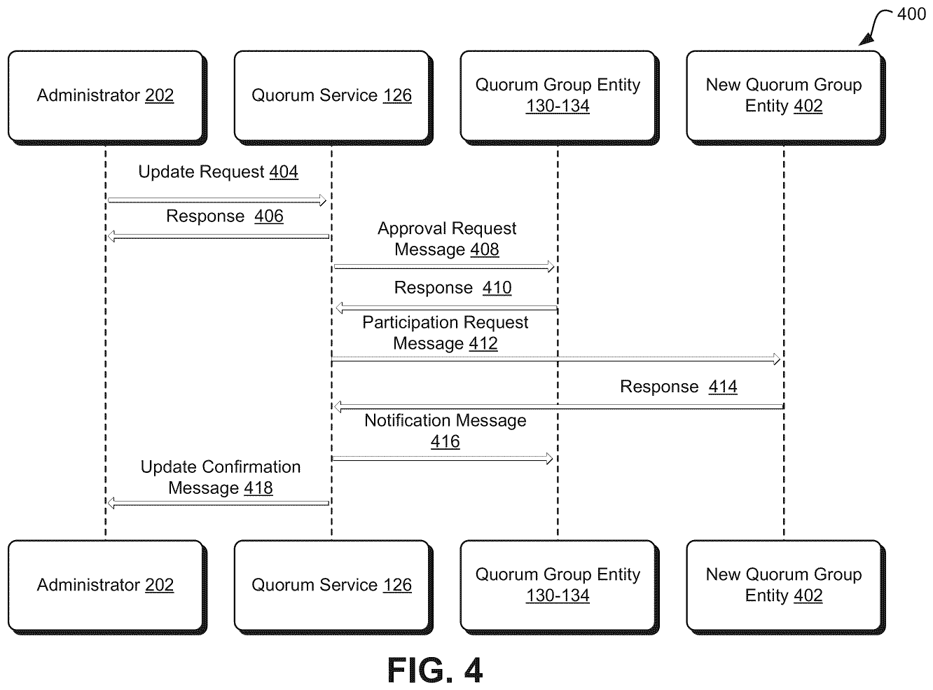

FIG. 4 illustrates an example update quorum group process 400 for adding or removing an entity to a quorum group, according to at least one embodiment. In at least one embodiment, the administrator 202, such as an administrator of the computer-implemented system 102, an administrator of the first account 104, an administrator of the backup service 110, or the like, generates an update request 404. In at least one embodiment, the administrator 202 can interface with the quorum service 126 to generate the update request 404. Alternatively, in at least one embodiment, the administrator 202 can communicate the update request 404 to the quorum service 126 via one or more other services associated with the computer-implemented system 102. In at least one embodiment, the administrator 202 uses a programmatic interface of the quorum service 126 to generate the update request 404. In at least one embodiment, the programmatic interface of the quorum service 126 can comprise one or more APIs, web pages, custom graphical user interfaces, command-line tools, or the like.

The update request 404 can identify one or more entities to add to a quorum group, such as the quorum group 128. In addition, or alternatively, the update request four and four can identify one or more entities to remove from a quorum group, such as the quorum group 128. The quorum service 126 can confirm that the administrator 202 has sufficient privileges to invoke the update request 404. Confirmation that the administrator 202 has sufficient privileges can require the exchange and confirmation that credentials possessed by the administrator 202 are sufficient for modifying the quorum group.

In response to the update request 404, the quorum service 126 can generate a response 406. The response can be provided to the administrator 202. The response 406, in at least one embodiment, can include information indicating acceptance of the update request 404. Furthermore, the response 406 can include information indicating that updating the quorum group is in process.

The quorum service 126 can generate an approval request message 408. The approval request message 408 can be an email or other message for delivery to each entity of the quorum group 128. The approval request message 408 can comprise a URL link associated with a URL or other interface of the quorum service 126. Availability to access the URL or other interface of the quorum service 126 can be limited to a particular time period and/or can be set to terminate based on a predetermined timeframe set by an administrator of the quorum service 126. In at least one embodiment, the approval request message 408 can list the one or more entities to be added and/or removed from the quorum group, such as the quorum group 128. In addition, the approval request message 408 can include a unique identifier generated to represent a quorum group update session triggered by the update request 404.

In at least one embodiment, the URL link can allow entities of the quorum group 128 to interface with the quorum service 126 to approve or reject the one or more entities to be added and/or removed from the quantum group, such as the quantum group 128. In at least one embodiment, accessing the quorum service 126 via the provided URL can cause the display of a web page that details the update request and can include specifics (e.g., email address, other contact information, name details, location details, etc.) of the one or more entities to be added and/or removed from the quantum group. In addition, in at least one embodiment, the web page can offer a mechanism that allows the at least three entities 130-134 to approve or reject the one or more entities to be added and/or removed from the quantum group.

The quorum service 126 monitors responses 410 to the update request received from one or more of the at least three entities 130-134. In at least one embodiment, the quorum service 126 can determine when the number of approvals from the at least three entities 130-134 equals or exceeds the threshold. In at least one embodiment, once the number of approvals from the at least three entities 130-134 equals or exceeds the threshold, the quorum service 126 executes updating the quorum group, such as the quorum group 128, to add and/or remove the one or more entities from the quorum group based on the update request 404.

In at least one embodiment, adding a new quorum group entity 402 to the quorum group, such as the quorum group 128, requires acceptance from the new quorum group entity 402. In at least one embodiment, the quorum service 126 generates a participation request message 412 that is communicated to the new quorum group entity 402. The participation request message 412 can be an email or other message for delivery to the new quorum group entity 402. The participation request message 412 can comprise a URL link associated with a URL or other interface of the quorum service 126. Availability to access the URL or other interface of the quorum service 126 can be limited to a particular time period and/or can be set to terminate based on a predetermined timeframe set by an administrator of the quorum service 126. In at least one embodiment, the participation request message 412 can include a request to access the URL to confirm participation in the quorum group. In addition, the participation request message 412 can include a unique identifier generated to represent a quorum group update session triggered by the update request 404.

In at least one embodiment, the quorum service 126 receives a response 414 from the new quorum group entity 402 confirming their acceptance to participate in the quorum group, such as the quorum group 128. In at least one embodiment, the response 414 is received via the URL or other interface of the quorum service 126, such as a programmatic interface comprising one or more APIs, web pages, custom graphical user interfaces, command-line tools, or the like. Based on at least the response 414 from the new quorum group entity 402, the quorum service 126 can generate a notification message 416. The notification message 416 can be sent to the quorum group entities 130-134 of the quorum group 128. The notification message 416 can list the one or more quorum group entities added and/or removed from the quorum group. Additionally, the quorum service 126, in at least one embodiment, can generate an update confirmation message 418. The update confirmation message 418 can be provided to the administrator 202 to confirm updating the quorum group is complete. The update confirmation message 418 can include various information, such as identifying quorum group entities added and/or removed from the quorum group, the unique identifier generated to represent a quorum group update session triggered by the update request 404, and so forth.

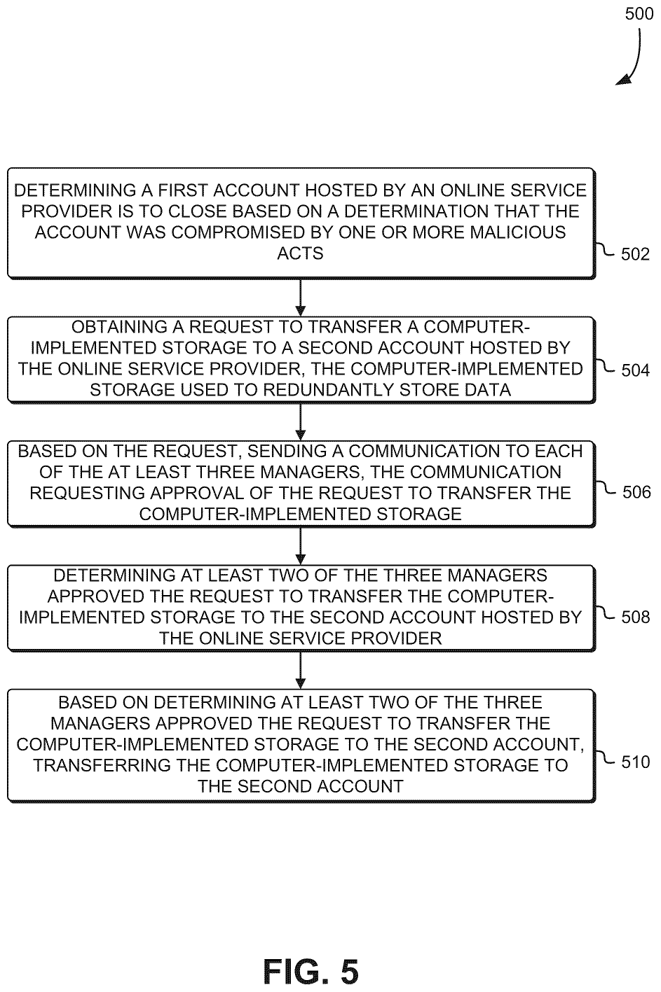

FIG. 5 illustrates an example flow diagram 500 that may be associated with one or more of the described system environments to process transferring a computer-implemented resource from a first account to a second account, according to at least one embodiment. In some implementations, the acts of the flow diagram 500 are executed by one or more computing devices of the example system environments described herein. The example system environments may execute computer-executable instructions incorporating at least some of the processing acts of the flow diagram 500 to provide transferring a computer-implemented resource from a first account to a second account, according to at least one embodiment.

The particular implementation of the technologies disclosed herein is a matter of choice dependent on the performance and other requirements of the computing device. Accordingly, the logical operations, also referred to as acts, described herein are referred to variously as states, operations, structural devices, acts, or modules. These states, operations, structural devices, acts, and modules can be implemented in hardware, software, firmware, special-purpose digital logic, and any combination thereof. It should be appreciated that more or fewer operations can be performed than shown in the figures and described herein. These operations can also be performed in a different order than those described herein. It should also be understood that the methods described herein can be ended at any time and need not be performed in their entireties.

Some or all operations of the methods described herein, and/or substantially equivalent operations, can be performed by execution of computer-readable instructions included on computer-storage media. The term “computer-readable instructions,” and variants thereof, as used in the description and claims, is used expansively herein to include routines, applications, application modules, program modules, system modules, programs, components, data structures, algorithms, and the like. Computer-readable instructions can be implemented on various system configurations, including single-processor or multiprocessor systems, minicomputers, mainframe computers, distributed computer systems, personal computers, hand-held computing devices, microprocessor-based, programmable consumer electronics, combinations thereof, and the like.

Thus, it should be appreciated that the logical operations described herein are implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules might be implemented in software, in firmware, in special-purpose digital logic, and any combination thereof.

At 502, a system or service determines a first account hosted by an online service provider is to close based on a determination that the account was compromised by one or more malicious acts, administration the first account managed at least in part through a first service accessible by one or more administrators associated with the first account. In at least one embodiment, determining the first account is to close is performed by one or more systems of the computer-implemented system 102. In at least one embodiment, determining the first account is to close is performed by one or more services of the computer-implemented system 102. In at least one embodiment, the first service accessible by the one or more administrators is the IAM service 108 of the first account 104. In at least one embodiment, the one or more malicious acts compromise the account such that an unauthorized entity obtains root access to the account or root access to the IAM service of the account. Specifically, the unauthorized entity compromised the account by creating or becoming an unauthorized root user able to update the account and settings of the account, to include account name, email addresses, root user passwords and or access keys, and the like.

At 504, a system or service obtains a request to transfer a computer-implemented storage to a second account hosted by the online service provider, the computer-implemented storage used to redundantly store data from one or more computer implemented storages linked to the first account, administration of the computer-implemented storage at least in part managed through a second service accessible by at least three managers linked to the computer-implemented storage. In at least one embodiment, one or more managers are linked to the computer-implemented storage to consider a transfer request associated with the computer-implemented storage. In at least one embodiment, the request to transfer is obtained by one or more systems of the computer-implemented system 102. In at least one embodiment, the second service is a quorum service, such as the quorum service 126. In at least one embodiment, the at least three managers associated with the second service comprise one or more of the quorum group entities 130-134 of the quorum group 128. In at least one embodiment, the computer-implemented storage used to redundantly store comprises the computer-implemented backup storage resource 112 and/or one or more of the datasets 114-118.

At 506, based on the request, a system or service sends a communication to each of the at least three managers, the communication requesting approval of the request to transfer the computer-implemented storage to the second account hosted by the online service provider, the communication including a notification to access the second service to respond to the request. In at least one embodiment, the system or service associated with the computer-implemented system 102. In at least one embodiment, the communication to each of the at least three managers can comprise the approval request message 306. In at least one embodiment, the communication requesting approval is sent by the quorum service 126.

At 508, a system or service determines at least two of the three managers approved the request to transfer the computer-implemented storage to the second account hosted by the online service provider. In at least one embodiment, the system or service is associated with the computer-implemented system 102. In at least one embodiment, determining that at least two of the three managers approved the request to transfer the computer-implemented storage is based on analysis of one or more responses 308 by the quorum service 126.

At 510, a system or service, based on determining at least two of the three managers approved the request to transfer the computer-implemented storage to the second account, transfers the computer-implemented storage to the second account hosted by the online service provider. In at least one embodiment, the system or service is associated with the computer-implemented system 102. In at least one embodiment, transferring the computer-implemented storage to the second account is executed by the backup service 136.

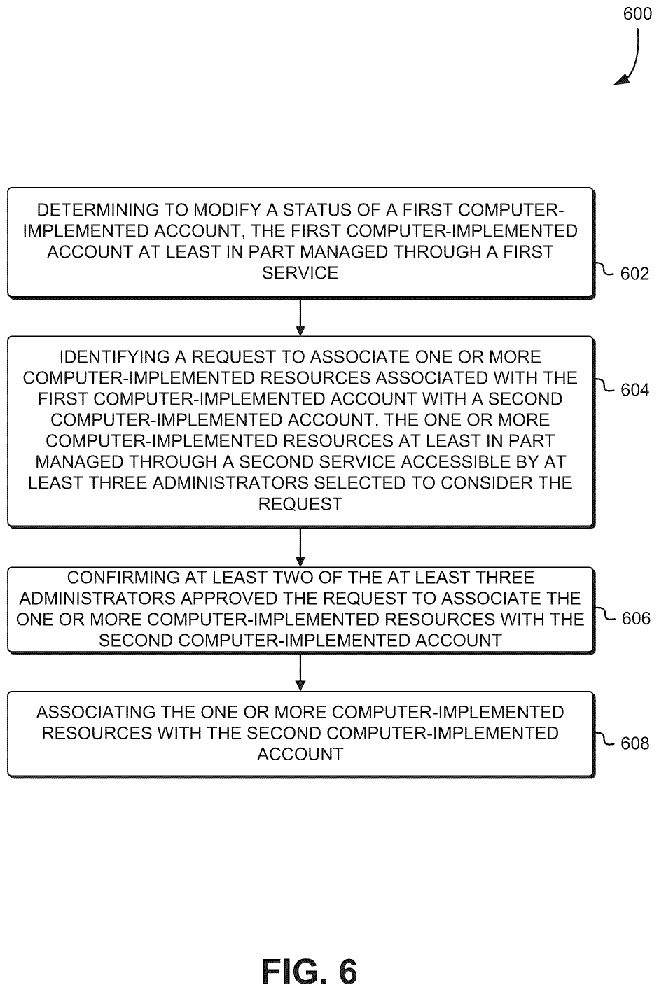

FIG. 6 illustrates an example flow diagram 600 that may be associated with one or more of the described system environments to process transferring a computer-implemented resource from a first account to a second account, according to at least one embodiment. In some implementations, the acts of the flow diagram 600 are executed by one or more computing devices of the example system environments described herein. The example system environments may execute computer-executable instructions incorporating at least some of the processing acts of the flow diagram 600 to provide transferring a computer-implemented resource from a first account to a second account, according to at least one embodiment.

At 602, a system or service determines to modify a status of a first computer-implemented account, the first computer-implemented account at least in part managed through a first service. In at least one embodiment, the system or service is associated with the computer-implemented system 102. In at least one embodiment, determining to modify the status of the first computer-implemented account is based on a finding that the first computer-implemented account was compromised by one or more malicious actors. In at least one embodiment, determining to modify the status of the first computer-implemented account is based on an administrative process involving transferring some or more of the resources of the first computer-implemented account to a second computer having implemented account. In at least one embodiment, the status of the first computer-implemented account is to be modified from active to closed or active to quarantined. At least one embodiment, the first computer-implemented account is managed through at least an IAM service of the computer-implemented system 102. The at least one embodiment, the first computer having implemented account is managed through at least the IAM service 108.

At 604, a system or service identifies a request to associate one or more computer-implemented resources associated with the first computer-implemented account with a second computer-implemented account, the one or more computer-implemented resources at least in part managed through a second service accessible by at least three administrators selected to consider the request. In at least one embodiment, any number of administrators can be selected to consider the request. In at least one embodiment, the system or service is associated with the computer-implemented system 102. In at least one embodiment, the request is generated by an administrator of the second computer having implemented account, such as the second account 106. In at least one embodiment, the request is identified by a quorum service, such as a quorum service 126. In at least one embodiment, the one or more computer-implemented resources comprise data. In at least one embodiment, the one or more computer-implemented resources comprise backup data. In at least one embodiment, the one or more computer-implemented resources comprise the computer-implemented backup storage resource 112 and/or one or more of the data sets 114-118. In at least one embodiment, one or more of the at least three administrators comprise entities of a quorum group, such as the quorum group 128. At least one embodiment, the first account corresponds to the first account 104 and the second account corresponds to the second account 106.

At 606, a system or service confirms at least two of the at least three administrators approved the request to associate the one or more computer-implemented resources with the second computer-implemented account. In at least one embodiment, the system or service is associated with the computer-implemented system 102. In at least one embodiment, the request corresponds to the transfer request 302.

At 608, a system or service associate the one or more computer-implemented resources with the second computer-implemented account. In at least one embodiment, the backup service 126 associate the one or more computer-in the resources with the second account.

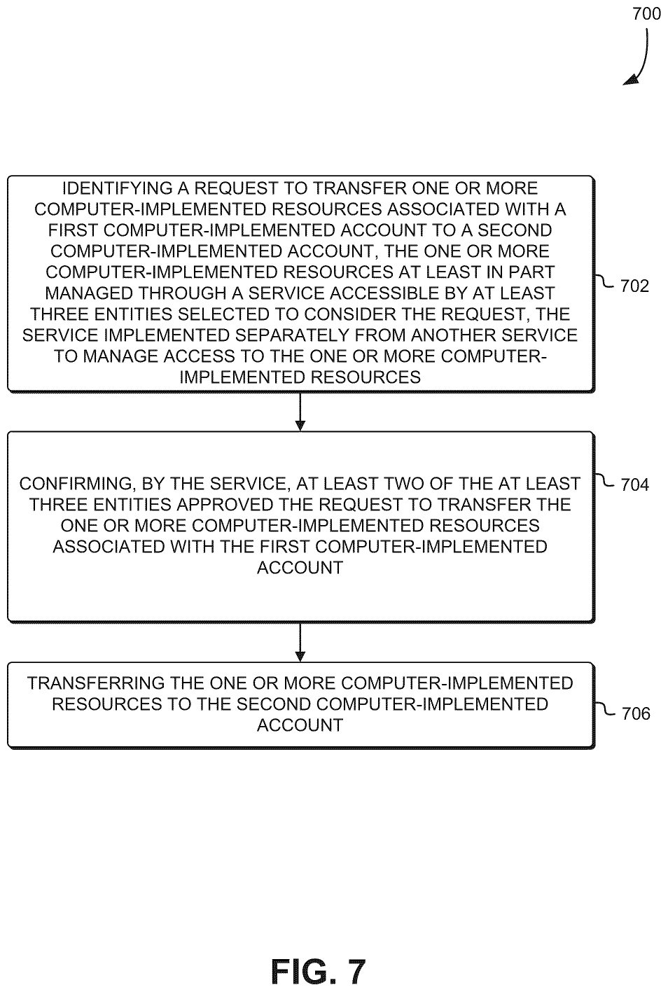

FIG. 7 illustrates an example flow diagram 700 that may be associated with one or more of the described system environments to process transferring a computer-implemented resource from a first account to a second account, according to at least one embodiment. In some implementations, the acts of the flow diagram 700 are executed by one or more computing devices of the example system environments described herein. The example system environments may execute computer-executable instructions incorporating at least some of the processing acts of the flow diagram 700 to provide transferring a computer-implemented resource from a first account to a second account, according to at least one embodiment.

At 702, a system or service identifies a request to transfer one or more computer-implemented resources associated with a first computer-implemented account to a second computer-implemented account, the one or more computer-implemented resources at least in part managed through a service accessible by at least three entities selected to consider the request, the service implemented separately from another service to manage access to the one or more computer-implemented resources. In at least one embodiment, any number of entities can be selected to consider the request. In at least one embodiment, the system or service is associated with the computer-implemented system 102. In at least one embodiment, the request is received by a quorum service, such as a quorum service 126. In at least one embodiment, the request is received from the second computer-implemented account, such as the second account 106. In at least one embodiment, the service accessible by the at least three entities is a quorum service 126. In at least one embodiment, the one or more computer-implemented resources correspond to the computer-implemented backup a storage resource 112 and/or one or more of the data sets 114-118.

In at least one embodiment, the other service to manage access to the one or more computer-implemented a resources corresponds to an IAM service, such as the IAM service 108 and/or the IAM service 138.

At 704, the service confirms at least two of the at least three entities approved the request to transfer the one or more computer-implemented resources associated with the first computer-implemented account. In at least one embodiment, the quorum service 126 confirms a approval. In at least one embodiment, the at least three entities correspond to entities 130-134.

At 706, a system or service transfers the one or more computer-implemented resources to the second computer-implemented account. In at least one embodiment, the second computer-implemented account corresponds to the second account 106. In at least one embodiment, transfer of the one or more computer-implemented resources is executed by at least the quorum service 126.

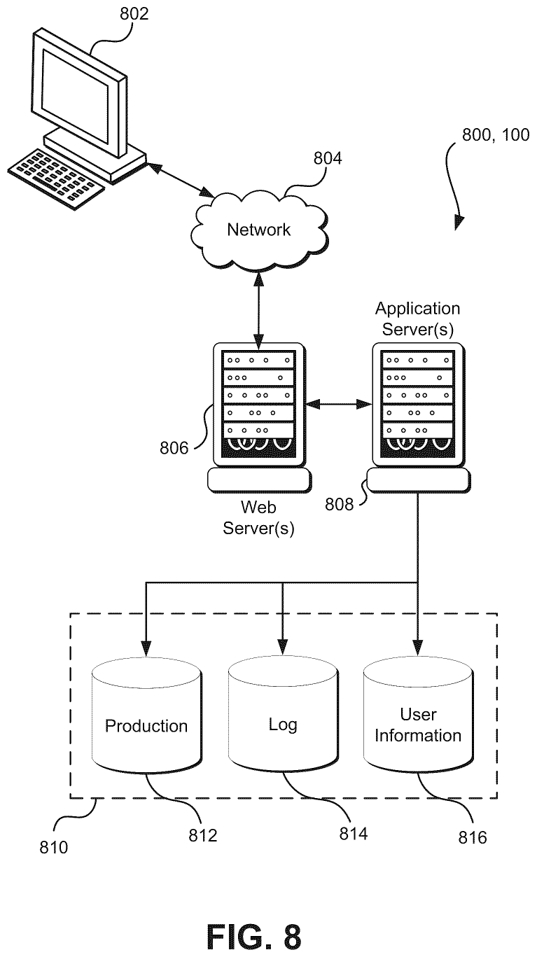

FIG. 8 illustrates aspects of an example system 800 for implementing aspects in accordance with an embodiment. As will be appreciated, although a web-based system is used for purposes of explanation, different systems may be used, as appropriate, to implement various embodiments. In an embodiment, the system includes an electronic client device 802, which includes any appropriate device operable to send and/or receive requests, messages, or information over an appropriate network 804 and convey information back to a user of the device. Examples of such client devices include personal computers, cellular or other mobile phones, handheld messaging devices, laptop computers, tablet computers, set-top boxes, personal data assistants, embedded computer systems, electronic book readers, and the like. In an embodiment, the network includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network is enabled by wired and/or wireless connections and combinations thereof. In an embodiment, the network includes the Internet and/or other publicly addressable communications network, as the system includes a web server 806 for receiving requests and serving content in response thereto, although for other networks an alternative device serving a similar purpose could be used as would be apparent to one of ordinary skill in the art.

In an embodiment, the illustrative system includes at least one application server 808 and a data store 810, and it should be understood that there can be several application servers, layers or other elements, processes or components, which may be chained or otherwise configured, which can interact to perform tasks such as obtaining data from an appropriate data store. Servers, in an embodiment, are implemented as hardware devices, virtual computer systems, programming modules being executed on a computer system, and/or other devices configured with hardware and/or software to receive and respond to communications (e.g., web service application programming interface (API) requests) over a network. As used herein, unless otherwise stated or clear from context, the term “data store” refers to any device or combination of devices capable of storing, accessing and retrieving data, which may include any combination and number of data servers, databases, data storage devices and data storage media, in any standard, distributed, virtual or clustered system. Data stores, in an embodiment, communicate with block-level and/or object-level interfaces. The application server can include any appropriate hardware, software and firmware for integrating with the data store as needed to execute aspects of one or more applications for the client device, handling some or all of the data access and business logic for an application.

In an embodiment, the application server provides access control services in cooperation with the data store and generates content including but not limited to text, graphics, audio, video and/or other content that is provided to a user associated with the client device by the web server in the form of HyperText Markup Language (“HTML”), Extensible Markup Language (“XML”), JavaScript, Cascading Style Sheets (“CSS”), JavaScript Object Notation (JSON), and/or another appropriate client-side or other structured language. Content transferred to a client device, in an embodiment, is processed by the client device to provide the content in one or more forms including but not limited to forms that are perceptible to the user audibly, visually and/or through other senses. The handling of all requests and responses, as well as the delivery of content between the client device 802 and the application server 808, in an embodiment, is handled by the web server using PUP: Hypertext Preprocessor (“PHP”), Python, Ruby, Perl, Java, HTML, XML, JSON, and/or another appropriate server-side structured language in this example. In an embodiment, operations described herein as being performed by a single device are performed collectively by multiple devices that form a distributed and/or virtual system.

The data store 810, in an embodiment, includes several separate data tables, databases, data documents, dynamic data storage schemes and/or other data storage mechanisms and media for storing data relating to a particular aspect of the present disclosure. In an embodiment, the data store illustrated includes mechanisms for storing production data 812 and user information 816, which are used to serve content for the production side. The data store also is shown to include a mechanism for storing log data 814, which is used, in an embodiment, for reporting, computing resource management, analysis or other such purposes. In an embodiment, other aspects such as page image information and access rights information (e.g., access control policies or other encodings of permissions) are stored in the data store in any of the above listed mechanisms as appropriate or in additional mechanisms in the data store 810.

The data store 810, in an embodiment, is operable, through logic associated therewith, to receive instructions from the application server 808 and obtain, update or otherwise process data in response thereto, and the application server 808 provides static, dynamic, or a combination of static and dynamic data in response to the received instructions. In an embodiment, dynamic data, such as data used in web logs (blogs), shopping applications, news services, and other such applications, are generated by server-side structured languages as described herein or are provided by a content management system (“CMS”) operating on or under the control of the application server. In an embodiment, a user, through a device operated by the user, submits a search request for a certain type of item. In this example, the data store accesses the user information to verify the identity of the user, accesses the catalog detail information to obtain information about items of that type, and returns the information to the user, such as in a results listing on a web page that the user views via a browser on the user device 802. Continuing with this example, information for a particular item of interest is viewed in a dedicated page or window of the browser. It should be noted, however, that embodiments of the present disclosure are not necessarily limited to the context of web pages, but are more generally applicable to processing requests in general, where the requests are not necessarily requests for content. Example requests include requests to manage and/or interact with computing resources hosted by the system 800 and/or another system, such as for launching, terminating, deleting, modifying, reading, and/or otherwise accessing such computing resources.

In an embodiment, each server typically includes an operating system that provides executable program instructions for the general administration and operation of that server and includes a computer-readable storage medium (e.g., a hard disk, random access memory, read only memory, etc.) storing instructions that, if executed by a processor of the server, cause or otherwise allow the server to perform its intended functions (e.g., the functions are performed as a result of one or more processors of the server executing instructions stored on a computer-readable storage medium).

The system 800, in an embodiment, is a distributed and/or virtual computing system utilizing several computer systems and components that are interconnected via communication links (e.g., transmission control protocol (TCP) connections and/or transport layer security (TLS) or other cryptographically protected communication sessions), using one or more computer networks or direct connections. However, it will be appreciated by those of ordinary skill in the art that such a system could operate in a system having fewer or a greater number of components than are illustrated in FIG. 8. Thus, the depiction of the system 800 in FIG. 8 should be taken as being illustrative in nature and not limiting to the scope of the disclosure.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java©, C, C# or C++, or any scripting language, such as Ruby, PUP, Perl, Python or TCL, as well as combinations thereof. In an embodiment, the one or more servers also include database servers, including without limitation those commercially available from Oracle®, Microsoft®, Sybase®, and IBM© as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A computer-implemented method, comprising:
determining a first account hosted by an online service provider is to close based on a determination that the first account was compromised by one or more malicious acts, administration of the first account managed at least in part through a first service accessible by one or more administrators associated with the first account;
obtaining a request to transfer a computer-implemented storage to a second account hosted by the online service provider, the computer-implemented storage used to redundantly store data from one or more computer-implemented storages linked to the first account, administration of the computer-implemented storage at least in part managed through a second service accessible by at least one manager linked to the computer-implemented storage;
based on the request, sending a communication to the at least one manager, the communication requesting approval of the request to transfer the computer-implemented storage to the second account hosted by the online service provider, the communication including a notification to access the second service to respond to the request;
determining the at least one manager approved the request to transfer the computer-implemented storage to the second account hosted by the online service provider; and
based on determining the at least one manager approved the request to transfer the computer-implemented storage to the second account, transferring the computer-implemented storage to the second account hosted by the online service provider.

2. The computer-implemented method according to claim 1, wherein the first service is an identity and access management (IAM) service to at least enforce permissions that control access to at least the computer-implemented storage, and the second service is separate from the IAM service and provides at least two interfaces to access the second service, the at least two interfaces comprising a first interface accessible by the one or more administrators associated with the first account to identify the at least one manager and a second interface accessible by the at least one manager to approve the request to transfer the computer-implemented storage to the second account.

3. The computer-implemented method according to claim 1, further comprising:
obtaining, via a programmatic interface associated with the second service, identification information of three managers, the three managers including the at least one manager;
contacting the three managers, by the second service and using the identification information, to invite the three managers to accept participation in a management group linked to the computer-implemented storage used to redundantly store the data from the one or more computer implemented storages linked to the first account; and
obtaining, by the second service, an acceptance from at least one of the three managers to participate in the management group linked to the computer-implemented storage.

4. The computer-implemented method according to claim 1, wherein obtaining the request to transfer comprises receiving the request to transfer from the second account hosted by the online service provider, the request at least comprising an identifier of the computer-implemented storage used to redundantly store the data from the one or more computer implemented storages linked to the first account.

5. A system, comprising:
one or more processors; and
memory that stores computer-executable instructions that are executable by the one or more processors to cause the system to:
determine to modify a status of a first computer-implemented account, the first computer-implemented account at least in part managed through a first service;
identify a request to associate one or more computer-implemented resources associated with the first computer-implemented account with a second computer-implemented account, the one or more computer-implemented resources at least in part managed through a second service accessible by at least one administrator selected to consider the request;
confirm the at least one administrator approved the request to associate the one or more computer-implemented resources with the second computer-implemented account; and
associate the one or more computer-implemented resources with the second computer-implemented account.

6. The system according to claim 5, wherein determining to modify the status of the first computer-implemented account comprises:
determining the first computer-implemented account was compromised by one or more malicious entities, and
modifying the status of the first computer-implemented account to identify that the first computer-implemented account is in quarantine, quarantining the first computer-implemented account including limiting user access to the first computer-implemented account.

7. The system according to claim 5, wherein the one or more computer-implemented resources associated with the first computer-implemented account comprise at least one computer-implemented storage to store backup data associated with the first computer-implemented account.

8. The system according to claim 5, wherein the first service is an identity and access management (IAM) service to at least enforce permissions that control access to the first computer-implemented account, and the second service is separate from the IAM service and provides at least two interfaces to access the second service, the at least two interfaces comprising a first interface accessible by one or more entities associated with the first computer-implemented account to identify the at least one administrator and a second interface accessible by the at least one administrator to approve the request to associate the one or more computer-implemented resources with the second computer-implemented account.

9. The system according to claim 5, wherein the computer-executable instructions that are executable by the one or more processors to are to further cause the system to:
obtain, via a programmatic interface associated with the second service, identification information of at least two administrators, the at least two administrators comprising the at least one administrator;
contact the at least two administrators, by the second service and using the identification information, to invite the at least two administrators to accept participation in a management group linked to the one or more computer-implemented resources; and
obtain, by the second service, an acceptance from at least one of the at least two administrators to participate in the management group linked to the one or more computer-implemented resources.

10. The system according to claim 5, wherein identifying the request to associate the one or more computer-implemented resources comprises receiving the request from the second computer-implemented account, the request at least comprising an identifier of the one or more computer-implemented resources.

11. The system according to claim 5, wherein the computer-executable instructions that are executable by the one or more processors to are to further cause the system to:
assign a first identifier identify the at least one administrator;
assign a second identifier to identify the one or more computer-implemented resources, and
link the first and second identifiers.

12. The system according to claim 5, wherein confirming the at least one administrator approved the request to associate the one or more computer-implemented resources with the second computer-implemented account comprises determining, by the second service, that a number of administrators that approved the request equals or exceeds a threshold number.

13. A computer-implemented method, comprising:
identifying a request to transfer one or more computer-implemented resources associated with a first computer-implemented account to a second computer-implemented account, the one or more computer-implemented resources at least in part managed through a service accessible by at least one entity selected to consider the request, the service implemented separately from another service to manage access to the one or more computer-implemented resources;
confirming, by the service, the at least one entity approved the request to transfer the one or more computer-implemented resources associated with the first computer-implemented account; and
transferring the one or more computer-implemented resources to the second computer-implemented account.

14. The computer-implemented method according to claim 13, further comprising:
determining the first computer-implemented account was compromised by one or more malicious entities, and
modifying a status of the first computer-implemented account to identify that the first computer-implemented account is in quarantine, quarantining the first computer-implemented account including limiting user access to the first computer-implemented account.

15. The computer-implemented method according to claim 13, wherein the one or more computer-implemented resources associated with the first computer-implemented account comprise at least one computer-implemented storage to store backup data associated with the first computer-implemented account.

16. The computer-implemented method according to claim 13, wherein the service comprises at least two interfaces to access the service, the at least two interfaces comprising a first interface accessible by one or more entities associated with the first computer-implemented account to identify the at least one entity and a second interface accessible by the at least one entity to approve the request to transfer the one or more computer-implemented resources associated with the first computer-implemented account to the second computer-implemented account.

17. The computer-implemented method according to claim 13, wherein the other service is an identity and access management (IAM) service to at least enforce permissions that control access to the first computer-implemented account.

18. The computer-implemented method according to claim 13, further comprising:
obtaining, via a programmatic interface associated with the service, identification information of the at least one entity;
contacting the at least one entity, by the service and using the identification information, to invite the at least one entity to accept participation in a management group linked to the one or more computer-implemented resources; and
obtaining, by the service, an acceptance from the at least one entity to participate in the management group linked to the one or more computer-implemented resources.

19. The computer-implemented method according to claim 13, wherein identifying the request to transfer the one or more computer-implemented resources associated with a first computer-implemented account comprises receiving the request from the second computer-implemented account, the request at least comprising an identifier of the one or more computer-implemented resources.

20. The computer-implemented method according to claim 13, further comprising:
assigning a first identifier to identify the at least one entity;
assigning a second identifier to identify the one or more computer-implemented resources, and
linking the first and second identifiers.
